(19) United States
(12) Patent Application Publication
(10) Pub. No.: US 2015/0064355 A1
(43) Pub. Date: Mar. 5, 2015

(54) METHOD AND APPARATUS FOR COATING PRINTHEAD

(71) Applicant: Xerox Corporation, Norwalk, CT (US)

(72) Inventors: J. Kirk McGlothlan, Beaverton, OR (US); Michael B. Meinhardt, Lake Oswego, OR (US); Donald Chitwood, Portland, OR (US)

(73) Assignee: Xerox Corporation, Norwalk, CT (US)

(21) Appl. No.: 14/016,535

(22) Filed: Sep. 3, 2013

(51) Int. Cl. B05D 3/04; B05D 1/26; B05D 1/02; B05D 3/02

(52) U.S. Cl. CPC B05D 3/04; B05D 3/0254; B05D 1/26; B05D 1/02
USPC 427/331; 118/63

(57) ABSTRACT

There is described a method for forming an ink jet print head. The method includes providing a printhead including a nozzle plate having a plurality of apertures and coating an anti-wetting composition on a surface of the nozzle plate while the plurality apertures in the ink jet aperture plate are maintained at a first pressure such that a plurality of menisci of the composition form over the plurality of apertures. The plurality of menisci are purged by increasing the first pressure at the plurality of apertures to a second pressure greater than the first pressure. The anti-wetting composition is cured. An apparatus for applying the coating is described.

### BACKGROUND

1. Field of Use

The present disclosure relates to process and apparatus for applying anti-wetting coatings to aperture plates of ink jet print heads.

2. Background

Fluid ink jet systems typically include one or more printheads having a plurality of ink jets from which drops of fluid are ejected towards a recording medium. The ink jets of a printhead receive ink from an ink supply chamber or manifold in the printhead which, in turn, receives ink from a source, such as a melted ink reservoir or an ink cartridge. Each ink jet includes a channel having one end in fluid communication with the ink supply manifold. The other end of the ink channel has an nozzle plate having apertures for ejecting drops of ink. The apertures of the nozzle plate are the openings used for jetting the ink. During operation, drop ejecting signals activate actuators in the printhead to expel drops of fluid from the apertures in the nozzle onto the recording medium. By selectively activating the actuators of the printhead to eject drops as the recording medium and/or printhead assembly are moved relative to one another, the deposited drops can be precisely patterned to form particular text and graphic images on the recording medium.

One difficulty faced by fluid ink jet systems is wetting, drooling or flooding of inks onto the printhead front face. Such contamination of the printhead front face can cause or contribute to blocking of the ink jet nozzles and channels, which alone or in combination with the wetted, contaminated front face, can cause or contribute to non-firing or missing drops, undersized or otherwise wrong-sized drops, satellites, or misdirected drops on the recording medium and thus result in degraded print quality.

Low adhesion coatings or anti-wetting coatings are provided on a nozzle plate of a printhead which resist contamination, drooling and flooding by ultra-violet (UV) curable phase change inks and solid inks (also referred to as phase change inks) and which properties remain even after many purge/maintenance cycles. However, application of the anti-wetting coatings and subsequent curing of the anti-wetting coatings can cause problems if the coatings get into the apertures of the nozzle plate. It would be desirable to provide a method and apparatus for applying anti-wetting coating that is inexpensive, repeatable and does not clog apertures of the face plate.

### SUMMARY

According to various embodiments, there is described a method for forming an ink jet print head. The method includes providing a printhead including a nozzle plate having a plurality of apertures, and coating an anti-wetting composition on a surface of the nozzle plate while the plurality apertures in the ink jet aperture plate are maintained at a first pressure such that a plurality of menisci of the composition form over the plurality of apertures. The plurality of menisci are purged by increasing the first pressure at the plurality of apertures to a second pressure greater than the first pressure. The anti-wetting composition is cured.

A further aspect disclosed herein is an apparatus for coating a printhead. The apparatus includes a mounting plate for securing the printhead having a nozzle plate having a plurality of apertures. The apparatus includes a coater for applying an anti-wetting composition on a surface of the nozzle plate wherein the mounting plate is configured to move the printhead past the coater. The apparatus includes a gas pump for maintaining the plurality of apertures in the printhead at a first pressure during the application of the anti-wetting composition. The first pressure allows the formation of a plurality of menisci of the anti-wetting composition over the plurality of apertures during the coating application. The gas pump increases the first pressure to a second pressure after the coating application to purge the menisci, wherein the second pressure is greater than the first pressure. The apparatus includes a heater for heating the anti-wetting composition.

A further aspect disclosed herein is a method of forming an ink jet print head. The method includes providing a printhead including a nozzle plate having a plurality of apertures. The method includes coating an anti-wetting composition includes an amorphous fluoropolymer in a perfluorinated solvent on a surface of the nozzle plate while the plurality of apertures in the nozzle plate are maintained at a first pressure of from about 2 inches to about 8 inches such that a plurality of menisci of the composition form over the plurality of apertures. The method includes purging the plurality of menisci by increasing the first pressure at the plurality of apertures to a second pressure greater than the first pressure. The anti-wetting composition is cured.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 is a cross-section of a printhead front face having an anti-wetting coating disposed on the nozzle plate in accordance with the present disclosure.

FIG. 2 is a schematic view of a coating apparatus for applying an anti-wetting coating on a nozzle plate of a printhead.

FIG. 3 is a chart showing the number of broken menisci of a test fluid at an applied fluid pressure.

It should be noted that some details of the figures have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

The printhead nozzle plate (or orifice plate or print head front face plate or aperture plate) can be made of any suitable material and can be of any configuration suitable to the device. Nozzle plates of square or rectangular shapes are typically selected due to ease of manufacture. Nozzle plates can be made of any suitable composition. In embodiments, nozzle plates or orifice plates are composed of stainless steel, steel, nickel, copper, aluminum, polyimide, or silicon. Nozzle plates can also be made of stainless steel selectively plated with a braze material such as gold.

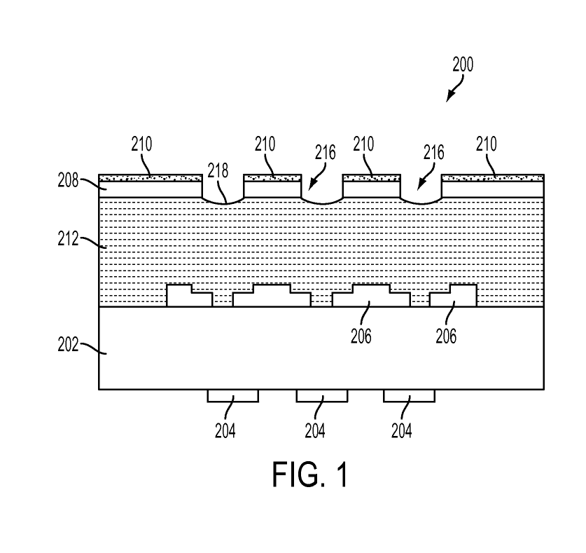

Anti-wetting coatings (AWCs) can be used with any type of print head. Referring to FIG. 1, a printhead 200 having a cured AWC 210 coating disposed thereon is illustrated. Printhead 200 includes a base substrate 202 with transducers 204 on one surface and acoustic lenses 206 on an opposite surface. Spaced from the base substrate 202 is a nozzle plate 208. The cured AWC 210 is disposed along nozzle plate 208. The base substrate 202 and the nozzle plate 208 define a channel which holds a flowing liquid 212 while the printhead 200 is in operation. The nozzle plate 208 contains a plurality of apertures 216. The transducers 204, acoustic lenses 206, and apertures 216 are all axially aligned such that an acoustic wave produced by a single transducer 204 will be focused by its aligned acoustics 206 at approximately a free surface 218 of the liquid 212 in its aligned aperture 216. When sufficient power is obtained a droplet is emitted from aperture 216.

The cured anti-wetting coating 210 is disposed on the printhead front face along nozzle plate 208 and provides the front face of the printhead 200 with sliding angle characteristics to prevent ink from accumulating near the apertures 216 and interfering with the jetting of the ink droplets. In specific embodiments, the cured AWC 210 provides the front face of the printhead 200 with sliding angle characteristics such that satellite droplets of UV gel ink and solid ink landing on the nozzle plate exhibit a low sliding angle.

The anti-wetting coatings are liquid when applied and then dried or cured. It is imperative that the anti-wetting coatings do not coat the inner surfaces of the apertures 216. This can lead to clogging of the apertures and poor performance of the printhead. The anti-wetting coating (AWC) increase the life requirements of printheads and printers using pigmented inks Variability in the reference coating leads to degradation of the critical meniscus pressure resulting in degraded print quality.

Disclosed herein is a method and apparatus for coating finished printheads 200 having nozzle plate 208 without getting the AWC into the apertures 216. A gas pressure control system is provided that controls the pressure in the printhead 200 during coating of the AWC, followed by a pressure change in the printhead 200 to a higher pressure for purging the menisci formed in the aperture 216 of the nozzle plate 208. During coating of the AWC menisci form over apertures 216 so the AWC is not applied to the surfaces of the apertures 216. The increase in pressure clears the apertures 216 of the formed menisci. After curing, the AWC 210 provides improved performance of the printhead 200.

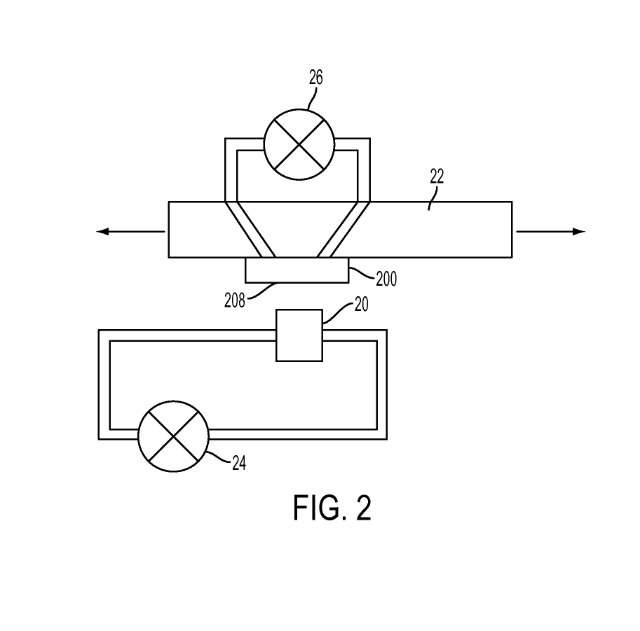

FIG. 2 shows a schematic of an apparatus used to accurately and repeatably coat an ink jet nozzle plate 208 without degrading the apertures within the nozzle plate 208. A mounting plate 22 securely holds the jet stack or print head 200. The printhead 200 having the nozzle plate 208 is positioned above a slot coater 20. In embodiments, spray coaters and flow coaters can also be used. A pump 26 including a pressure regulator provides air to the printhead 200 at a pressure which can be adjusted. The mounting plate 22 is movable in the directions of the arrows. The gap between in the slot coater 20 and the nozzle plate 208 is from about 0.005 inches to about 0.040 inches. An anti-wetting coating solution is pumped through the slot coater 20 by pump 24. The slot coater applies the solution to the nozzle plate 208 as the mounting plate 22 holding the printhead 200 is moved over the slot coater 20. During the coating, the pressure of the air in the printhead 200 is kept at from about 2 inches of water to about 8 inches of water, or in embodiments from about 2.5 inches of water to about 7 inches of water, or from about 5 inches of water to about 7 inches of water.

During the coating process menisci of the anti-wetting coating form on the apertures in the nozzle plate 208. The pressure prevents the AWC solution from entering the apertures. After the coating, the pressure of the air in the printhead is increased to purge the menisci in the apertures of the nozzle plate 208. The pressure during the purge is from about 40 inches of water to about 100 inches of water, or in embodiments form about 50 inches of water to about 95 inches of water, or from about 50 inches of water to about 90 inches of water. The AWC is then cured to form a cured AWC 210. The curing is conducted by a heater in the mounting plate or a separate heater.

The wet coating is heated to an appropriate temperature for removal of solvent and curing of the coating. After coating the liquid AWC on the nozzle plate 208, the liquid AWC is heated. In embodiments, the coating is heated to a temperature of from about 100° C. to about 180° C. for about 5 to about 60 minutes. In embodiments, after drying and curing, the AWC has a thickness of from about 100 nm to about 700 nm or from about 150 nm to about 650 nm, or from about 200 nm to about 600 nm.

Advantages of this system include the creation of a monolithic film of uniform surface energy. This in turn allows maintenance of critical meniscus pressures permitting ink to remain stably within the apertures until ejection is required.

The anti-wetting properties of the polymer film delivered by this method enable efficient printhead maintenance procedures by maintaining high ink fluid contact angles over the intended usage life.

The wet coating can be any suitable thickness.

The cured AWC of the disclosure has a low sliding angle of from about 1° to about 30°. The sliding angle, is a measure of self-cleaning behavior of the cured AWC. When the cured AWC in accordance with the present disclosure is on the left side of the nozzle plate, and the right hand side of the plate is uncoated, as the plate, elevated at an angle of about 30°, is heated up from room temperature, a film is formed as the drops flow down the nozzle plate on the right hand side and sticks to it. However on the left hand side, the drops slide down the plate without leaving any residue, illustrating the self-cleaning behavior of the cured AWC.

The cured AWC has a water contact angle of from about 70° to about 140°, or in embodiments from about 80° to about 130°, or in embodiments from about 100° to about 130°. The cured AWC of the disclosure has a hexadecane contact angle of from about 50° to about 80°, or in embodiments from about 55° to about 75°, or in embodiments from about 60° to about 70°. The cured AWC of the disclosure has a diiodomethane contact angle of from about 60° to about 110°, or in embodiments from about 75° to about 105°, or in embodiments from about 90° to about 100°.

In embodiments, the liquid AWC can include amorphous perfluorinated polymers that are soluble in perfluorinated solvents such as FC-40 and FC-70 available from 3M. Examples of amorphous perfluorinated polymers include Teflon® AF 1600 and Teflon® AF 2400.

In embodiments, suitable liquid AWCs include a polymer or oligomer containing an isocyanate functional group; a suitable polymer or oligomer containing a hydroxyl functional group; a suitable hydroxyl functionalized polymer or oligomer containing at least one polysiloxane unit; and optionally, a hydroxyl functionalized fluoro-crosslinking material. In embodiments, the liquid AWC include an isocyanate, a polylol; and a hydroxyl functionalized polysiloxane. In one embodiment, the liquid AWC described herein can include Components A, B, and C, wherein Component A can be a hydroxyl functionalized polyester, such as Desmophen® (available from Bayer Materials Science); Component B can be an isocyanate, such as Desmodur® or Bayhydur® (available from Bayer Materials Science); and Component C can be a hydroxyl functionalized polysiloxane crosslinking material, such as BYK-Silclean® (available from BYK Additives and Instruments). Such liquid coatings are described in US Pub. 2011/0122195 incorporated in its entirety by reference herein.

Component A of the AWC can be any suitable polymer or oligomer containing hydroxyl (—OH) functional groups. For example, Component A can be selected from the group consisting of hydroxyl functional polymers or oligomers such as polyvinyls, polystyrenes, polyacrylates, polyester, polyethers, and mixtures thereof. In a specific embodiment, Component A is a hydroxyl functional polyacrylate resin sold under the name Desmophen® A 870 BA, available from Bayer Materials Science.

Component B of the liquid AWC can be any suitable polymer or oligomer containing isocyanate (—NCO) functional groups. For example, Component B can be selected from the group consisting of isocyanate functional polymers or oligomers such as polyvinyls, polystyrenes, polyester, polyacrylates, and mixtures thereof. In embodiments, the isocyanate can be selected from the group consisting of diphenylmethane diisocyanate, toluene diisocyanate, hexamethylene diisocyanate, isophorone diisocyanate, or suitable polymer or oligomer containing isocyanate (—NCO) functional groups, and mixtures thereof. In a specific embodiment, Component B is a solvent free aliphatic isocyanate resin based on hexamethylene diisocyanate sold under the name Desmodur® N 3300 A, available from Bayer Materials Science.

Component C of the liquid AWC can be any suitable hydroxyl functionalized polymer or oligomer containing polysiloxane units. For example, Component C can be selected from the group consisting of hydroxyl functionalized polymers or oligomers containing polysiloxane unit/s such as polyvinyls, polystyrenes, polyacrylates, polyethers, and mixtures thereof. In a specific embodiment, Component C is a polymer consisting of polysiloxane side-chains on hydroxyl-functional polyacrylate backbone sold under the name BYK-Silclean® 3700, available from BYK Additives and Instruments.

The ink jet printhead having the AWC disposed on the nozzle plate can be used with any suitable ink. In a specific embodiment, the ink comprises a phase change or solid ink, or a UV gel ink. Phase change inks for color printing typically comprise a phase change ink carrier composition which is combined with a phase change ink compatible colorant. In a specific embodiment, a series of colored phase change inks can be formed by combining ink carrier compositions with compatible subtractive primary colorants. The subtractive primary colored phase change inks can comprise four component dyes, namely, cyan, magenta, yellow and black, although the inks are not limited to these four colors. These subtractive primary colored inks can be formed by using a single dye or a mixture of dyes. For example, magenta can be obtained by using a mixture of Solvent Red Dyes or a composite black can be obtained by mixing several dyes. U.S. Pat. No. 4,889,560, U.S. Pat. No. 4,889,761, and U.S. Pat. No. 5,372,852, the disclosures of each of which are totally incorporated herein by reference, teach that the subtractive primary colorants employed can comprise dyes from the classes of Color Index (C.I.) Solvent Dyes, Disperse Dyes, modified Acid and Direct Dyes, and Basic Dyes. The colorants can also include pigments, as disclosed in, for example, U.S. Pat. No. 5,221,335, the disclosure of which is totally incorporated herein by reference. U.S. Pat. No. 5,621,022, the disclosure of which is totally incorporated herein by reference, discloses the use of a specific class of polymeric dyes in phase change ink compositions. Compositions suitable for use as phase change ink carrier compositions are known. Exemplary suitable carrier materials can include paraffins, microcrystalline waxes, polyethylene waxes, ester waxes, fatty acids and other waxy materials, fatty amide containing materials, sulfonamide materials, resinous materials made from different natural sources (tall oil rosins and rosin esters, for example), and many synthetic resins, oligomers, polymers, and copolymers.

Specific embodiments will now be described in detail. These examples are intended to be illustrative, and not limited to the materials, conditions, or process parameters set forth in these embodiments. All parts are percentages by solid weight unless otherwise indicated.

### EXAMPLES

A series of nozzle plates on printheads were coated with various antiwetting coatings. It was found that the better th coating, the higher the meniscus pressure. The critical meniscus pressure is the pressure of the fluid head of the printhead, measured in inches of water, at which the interfacial tension of the cured AWC treatment cannot hold back an incremental increase in applied fluid head pressure. It was found that amorphous Teflon® either AF1600 or AF2400 in a perfluorinated solvent such as FC-40 or FC-70 exhibited the highest critical meniscus pressure of about 6 to 7 inches of water, which is higher in absolute terms and contains a distribution of failures much more narrow than the reference treatment.

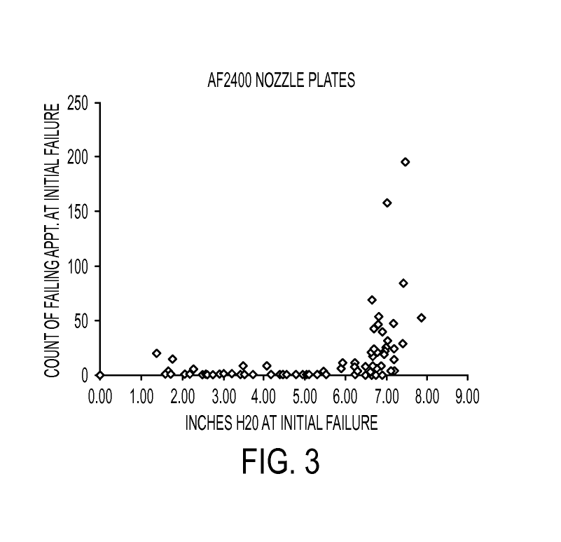

FIG. 3 is a compilation data from Teflon® AF AWC coated nozzle plates and shows the count of apertures at their critical meniscus pressures as a function of the applied fluid pressure. The cured AWC provides a minimum critical pressure of about 6.5 inches of water.

Other embodiments of the present teachings will be apparent to those skilled in the art from consideration of the specification and practice of the present teachings disclosed herein. It is intended that the specification and examples be considered as exemplary only, with the true scope and spirit of the present teachings being indicated by the following claims.

What is claimed is:

1. A method of forming an ink jet print head, the method comprising:
providing a printhead including a nozzle plate having a plurality of apertures;
coating an anti-wetting composition on a surface of the nozzle plate while the plurality of apertures in the nozzle plate are maintained at a first pressure such that a plurality of menisci of the composition form over the plurality of apertures;
purging the plurality of menisci by increasing the first pressure at the plurality of apertures to a second pressure greater than the first pressure; and
curing the anti-wetting composition.

2. The method of claim 1, wherein the first pressure is from about 2 inches of water to about 8 inches of water.

3. The method of claim 1, wherein the second pressure is from about 40 inches of water to about 100 inches of water.

4. The method of claim 1, wherein the anti-wetting composition comprises an amorphous perfluorinated polymer.

5. The method of claim 1, wherein the anti-wetting composition comprises a suitable polymer or oligomer containing an isocyanate functional group; a suitable polymer or oligomer containing a hydroxyl functional group; a suitable hydroxyl functionalized polymer or oligomer containing at least one polysiloxane unit; and optionally, a hydroxyl functionalized fluoro-crosslinking material.

6. The method of claim 1, wherein the cured anti-wetting composition has a thickness of from about 100 nm to about 700 nm.

7. The method of claim 1, wherein the nozzle plate comprises a material selected from the group consisting of: stainless steel, steel, nickel, copper, aluminum, polyimide, and silicon.

8. The method of claim 1, wherein the cured anti-wetting composition has a low sliding angle of from about 1° to about 30°.

9. The method of claim 1, wherein the cured anti-wetting composition has a water contact angle of from about 70° to about 140°.

10. The method of claim 1, wherein the cured anti-wetting composition has a hexadecane contact angle of from about 40° to about 80°.

11. The method of claim 1, wherein the cured anti-wetting composition has a diiodomethane contact angle of from about 60° to about 110°.

12. The method of claim 1, wherein the coating comprises a slot coating.

13. An apparatus for coating a printhead, the apparatus comprising:
a mounting plate for securing the printhead having a nozzle plate having a plurality of apertures;
a coater for applying an anti-wetting composition on a surface of the nozzle plate plate wherein the mounting plate is configured to move the printhead past the coater;
a gas pump for maintaining the plurality of apertures in the printhead at a first pressure during the application of the anti-wetting coating which forms a plurality of menisci of the anti-wetting composition over the plurality of apertures during the application of the coating, and wherein the gas pump increases the first pressure to a second pressure after the application of the coating to purge the menisci, wherein the second pressure is greater than the first pressure; and
a heater for heating the anti-wetting composition.

14. The apparatus of claim 13, wherein the coater is selected from the group consisting of a slot coater, a flow coater and a spray coater.

15. The apparatus of claim 13, further comprising a pressure regulator for controlling the gas pump pressure.

16. The apparatus of claim 13, wherein the coater is space a distance of from about 0.005 inches to about 0.040 inches from the nozzle plate.

17. A method of forming an ink jet print head, the method comprising:
providing a printhead including a nozzle plate having a plurality of apertures;
coating an anti-wetting composition comprising an amorphous fluoropolymer in a perfluorinated solvent on a surface of the nozzle plate while the plurality of apertures in the nozzle plate are maintained at a first pressure of from about 2 inches to about 8 inches such that a plurality of menisci of the composition form over the plurality of apertures;
purging the plurality of menisci by increasing the first pressure at the plurality of apertures to a second pressure greater than the first pressure; and
curing the anti-wetting composition.

18. The method of claim 17, wherein the nozzle plate comprises a material selected from the group consisting of: stainless steel, steel, nickel, copper, aluminum, polyimide, and silicon.

19. The method of claim 17, wherein the cured anti-wetting composition has a low sliding angle of from about 1° to about 30°.

20. The method of claim 17, wherein the cured anti-wetting composition has a water contact angle of from about 70° to about 140°.
